(19) United States
(12) Patent Application Publication
(10) Pub. No.: US 2026/0045797 A1
(43) Pub. Date: Feb. 12, 2026

(54) Method And Device For Controlling Energy Exchanges Between A Plurality Of Energy Systems

(71) Applicant: Siemens Aktiengesellschaft, München (DE)

(72) Inventors: Arvid Amthor, Grabfeld OT Nordheim (DE); Sebastian Schreck, Nürnberg (DE); Thomas Schütz, Fürth (DE); Robin Sudhoff, Essen (DE)

(73) Assignee: Siemens Aktiengesellschaft, München (DE)

(21) Appl. No.: 18/998,816

(22) PCT Filed: Jul. 20, 2023
(86) PCT No.: PCT/EP2023/070124

§ 371 Date: Jan. 27, 2025

(30) Foreign Application Priority Data
Jul. 28, 2022 (EP) 22187565.1

(51) Int. Cl. H02J 3/00

(52) U.S. Cl. CPC H02J 3/003; H02J 2203/20; H02J 2310/14; H02J 2310/60

(57) ABSTRACT

Various embodiments include a method for controlling energy exchanges between energy systems via a power grid using a central control device. At least one of the energy systems comprises a heat generation installation converting electrical energy into heat. An example method includes: providing an electrical load forecast

$${p}_{t}^{e}$$

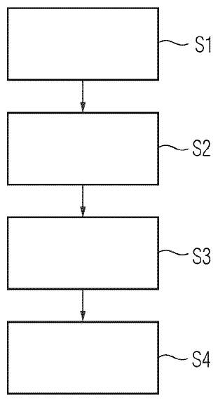

for the heat generation installation required to cover an envisaged thermal load

$${\dot{q}}_{t}^{thermal} ;$$

transmitting the electrical load forecast

$${p}_{t}^{e}$$

to the control device, wherein other energy systems also transmit respective electrical load forecasts to the control device; ascertaining electric powers

$${P}_{t}^{e}$$

associated with energy exchanges using the control device, on the basis of transmitted electrical load forecasts

$${p}_{t}^{e} ,$$

executed by an optimization method for minimizing an associated target function minimizing a number of starts

$${y}_{t}^{heat}$$

of the heat generation installation for covering the envisaged thermal load

$${\dot{q}}_{t}^{thermal} ;$$

and controlling energy exchanges according to the electric powers

$${P}_{t}^{e}$$

using the control device.

### CROSS-REFERENCE TO RELATED APPLICATIONS

This application is a U.S. National Stage Application of International Application No. PCT/EP2023/070124 filed Jul. 20, 2023, which designates the United States of America, and claims priority to EP Application No. 22187565.1 filed Jul. 28, 2022, the contents of which are hereby incorporated by reference in their entirety.

### TECHNICAL FIELD

The present disclosure relates to energy exchanges. Various embodiments of the teachings herein include methods and/or systems for controlling energy exchange between a plurality of energy systems.

### BACKGROUND

Energy systems, for example in urban districts, municipalities, buildings, industrial installations or similar, typically comprise various technical energy installations, for example generating, consumption and/or storage installations. A most efficient possible allocation of energy generated and consumed in the overall system, and of energy exchanges via an associated distribution network (power grid), is a technical challenge which, for example, can be met by means of a local energy market. In technical terms, the local energy market is constituted by a central control device for controlling energy exchanges with respect to energy systems. A control device of this type is known, for example, from document EP 3518369 A1.

In principle, however, local energy markets are geared towards electrical networks (power grids). Typically, the thermal aspect of energy systems, for example in residential buildings, is not explicitly considered. However, heat accounts for approximately 70 percent of the energy demand of average households. In principle, demand for electrical energy which is employed for heat generation can also be managed on the local energy market. For this purpose, however, it would be necessary to consider heat generation installations which are employed for heat generation in the same way as conventional electrical installations, in the context of the local energy market. Specific technical requirements governing heat generation installations thus remain unconsidered.

### SUMMARY

The teachings of the present disclosure may provide improved integration of heat generated by a heat generation installation into a local energy market. For example, some embodiments include a method for controlling energy exchanges between a plurality of energy systems via a power grid by means of a control device which is central to the energy systems, wherein at least one of the energy systems comprises a heat generation installation which converts electrical energy from the power grid into heat, characterized by the following:

(S1) providing an electrical load forecast

$${p}_{t}^{e}$$

for the heat generation installation, in order to cover an envisaged thermal load

$${\dot{q}}_{t}^{thermal} ;$$

(S2) transmitting the electrical load forecast

$${p}_{t}^{e}$$

thus provided to the control device, wherein other energy systems also transmit respective electrical load forecasts to the control device; (S3) ascertaining electric powers

$${P}_{t}^{e}$$

associated with energy exchanges by way of the control device, on the basis of transmitted electrical load forecasts

$${p}_{t}^{e}$$

thus provided, which ascertainment is executed by means of an optimization method for minimizing an associated target function, which target function is designed such that the number of starts

$${y}_{t}^{h e a t}$$

of the heat generation installation for covering the envisaged thermal load

$${\dot{q}}_{t}^{thermal}$$

is minimized; and (S4) controlling energy exchanges according to the electric powers

$${P}_{t}^{e}$$

thus ascertained, by means of the control device.

In some embodiments, the heat generation installation is configured as a heat pump.

In some embodiments, the electrical load forecast

$${p}_{t}^{e}$$

is ascertained from a thermal load forecast

$${\dot{q}}_{t}^{thermal}$$

according to

$${p}_{t}^{e} = {\dot{q}}_{t}^{t hermal} / {COP}_{t} ,$$

wherein COPₜ is the performance index of the heat pump.

In some embodiments, an external temperature is captured, and the performance index COPₜ is determined according to the external temperature thus captured.

In some embodiments, the target function comprises a term having the formula

$${ξ}^{wear} \cdot {\sum }_{t} {y}_{t}^{heat}$$

for minimizing the number of starts

$${y}_{t}^{heat} ,$$

wherein ξ^{wear} is configured as a wear factor and

$${y}_{t}^{heat}$$

as a binary variable, which characterizes the number of starts.

In some embodiments, further binary variables

$${x}_{t}^{h e a t} and {z}_{t}^{heat}$$

are employed in the optimization method, wherein

$${x}_{t}^{h e a t}$$

characterizes the operating status of the heat generation installation and

$${z}_{t}^{h e a t}$$

characterizes the number of stops of the heat generation installation, and the ancillary conditions

$${x}_{t}^{h e a t} - {x}_{t - 1}^{h e a t} = {y}_{t}^{h e a t} - {z}_{t}^{h e a t} and {y}_{t}^{h e a t} + {z}_{t}^{h e a t} \leq 1$$

are employed in the optimization method.

In some embodiments, the energy system additionally comprises a thermal store which is thermally coupled to the heat generation installation, wherein the target function is configured such that storage losses of the thermal store are minimized.

In some embodiments, the target function comprises a term having the formula

$${ξ}^{loss} \cdot {\sum }_{t} {\dot{Q}}_{t}^{thermal}$$

for minimizing storage losses, wherein ξ^{loss} is a thermal weighting factor.

In some embodiments, further ancillary condition

$${P}_{t}^{e , min} {x}_{t}^{heat} \leq {P}_{t}^{e} \leq {P}_{t}^{e , max} {x}_{t}^{heat}$$

is employed in the optimization method, wherein

$${P}_{t}^{e , min}$$

is a minimum making capacity and

$${P}_{t}^{e , max}$$

is the rated capacity of the heat generation installation.

As another example, some embodiments include a control device for controlling energy exchanges between a plurality of energy systems via a power grid, wherein at least one of the energy systems comprises a heat generation installation which converts electrical energy from the power grid into heat, characterized in that the control device is configured and designed: to receive an electrical load forecast

$${p}_{t}^{e}$$

provided for the heat generation installation in order to cover an envisaged thermal load

$${\dot{q}}_{t}^{thermal} ,$$

and to receive further respective electrical load forecasts from the further energy systems; to ascertain electric powers

$${P}_{t}^{e}$$

associated with energy exchanges on the basis of envisaged electrical load forecasts

$${p}_{t}^{e}$$

thus transmitted, which ascertainment is executed by means of an optimization method for minimizing an associated target function, which target function is designed such that the number of starts

$${y}_{t}^{heat}$$

of the heat generation installation for covering the envisaged thermal load

$${\dot{q}}_{t}^{thermal}$$

is minimized; and to control energy exchanges according to the electric powers

$${P}_{t}^{e}$$

thus ascertained.

### BRIEF DESCRIPTION OF THE DRAWINGS

Further advantages, features, and details of the teachings herein proceed from the exemplary embodiments described hereinafter, and from the drawing. The figure shows a schematic representation of a flow diagram of an example method incorporating teachings of the present disclosure. Identical, equivalent, or identically functioning elements can be identified in the figures by the same reference symbols.

### DETAILED DESCRIPTION

An example method incorporating teachings of the present disclosure for controlling energy exchanges between a plurality of energy systems via a power grid by means of a control device which is central to the energy systems, wherein at least one of the energy systems comprises a heat generation installation which converts electrical energy from the power grid into heat, is characterized by at least the following:
providing an electrical load forecast

$${p}_{t}^{e}$$

for the heat generation installation, in order to cover an envisaged thermal load

$${\dot{q}}_{t}^{thermal} ;$$

transmitting the electrical load forecast

$${p}_{t}^{e}$$

thus provided to the control device, wherein other energy systems also transmit respective electrical load forecasts to the control device;
ascertaining electric powers

$${P}_{t}^{e}$$

(target values) associated with energy exchanges by way of the control device, on the basis of transmitted electrical load forecasts

$${p}_{t}^{e}$$

thus provided, which ascertainment is executed by means of an optimization method for minimizing an associated target function, which target function is designed such that the number of starts

$${y}_{t}^{heat}$$

of the heat generation installation for covering the envisaged thermal load

$${\dot{q}}_{t}^{thermal}$$

is minimized; and
controlling energy exchanges according to the electric powers

$${P}_{t}^{e}$$

thus ascertained, by means of the control device.

The methods described herein and/or one or more functions, features and/or steps of the methods, and/or of one of the configurations thereof, can be computer-supported. In some embodiments, the control device comprises one or more computing units which are configured and designed, for example by means of commands, to implement the digital execution of the optimization method and to ascertain the electric power or target powers associated with energy exchanges.

In structural terms, in particular, the IPCC Fifth Assessment Report defines an energy system as: “All components involved in the generation, conversion, supply and use of energy” (Annex I, page 1261). Energy systems typically comprise multiple components, in particular technical energy installations, for example energy conversion installations, consumption installations and/or storage installations. Energy systems can generate and/or supply multiple forms of energy (multimodal energy systems). In particular, an energy system of this type delivers one or more forms of energy for a load, for example a building or a residential building, an industrial installation or private installations, which delivery, in particular, is executed by a conversion of various forms of energy, by a transmission of various forms of energy and/or by means of stored forms of energy. In other words, various forms of energy, for example heat, cold or electrical energy, are mutually associated by means of the multimodal energy system with respect to the generation, delivery and/or storage thereof. Energy systems comprise, for example, buildings, in particular residential buildings, and/or office buildings and/or industrial installations.

By way of a technical energy installation, the energy system can comprise one or more of the following components: power generators, combined heat and power plants, in particular cogeneration plants, gas boilers, diesel generators, heat pumps, compression refrigeration machines, absorption refrigeration machines, pumps, district heating systems, energy transfer lines, wind turbines or wind power installations, photovoltaic installations, energy stores, in particular accumulator batteries, biomass installations, biogas installations, waste incineration installations, industrial installations, conventional power plants and/or similar.

The method are thus based upon multiple energy systems, for example buildings, which exchange energy via a power grid. Energy systems can inject power into and/or extract power from the power grid at a specific time point. By means of a specific time range for the injection of power into and/or the extraction of power from the power grid, a specific energy or quantity of energy exchanged between energy systems is formed, i.e. an energy exchange is executed between the energy systems. At least one of the energy systems comprises a heat generation installation, which employs electrical energy for the supply or coverage of heat demand.

Energy exchanges between energy systems are controlled by means of the control device which is central to the energy systems. Control is executed by means of the control device, which is configured for executing an optimization method. In some embodiments, the central control device forms a local energy market.

An optimization method within the meaning of the present disclosure is a numerical method, wherein target values are ascertained for powers which form the basis of energy exchanges. The abovementioned powers or power values are variables of an established target function, which is minimized or maximized in the context of the optimization method. By means of a corresponding mathematical sign, a transition from a minimum to a maximum can be executed at any time.

In other words, the minimum or maximum target function establishes time-dependent powers, or the target values thereof, for the purposes of control. The target function typically models a technical objective which is pursued for energy exchanges, for example an optimum matching of generation and consumption, a lowest possible emission of carbon dioxide or a highest possible energy conversion. In the present case, the target function is minimized and is configured such that the number of starts of the heat generation installation which are required for the coverage of heat demand, optionally involving the employment of a flexibility of heat generation, is minimized. The term “flexibility” describes a facility for the temporal displacement of heat generation.

An electrical load forecast

$${p}_{t}^{e}$$

is provided for the heat generation installation, in order to cover an envisaged thermal load

$${\dot{q}}_{t}^{thermal} .$$

The electrical load forecast thus provided indicates what electric power, and at what time, it would be necessary for the heat generation installation to extract from the power grid, in order to cover the envisaged time-dependent thermal load. With respect to a local energy market, the electrical load forecast can correspond to a maximum (time-dependent) power which the energy system intends to extract, at a maximum, for the coverage of the thermal load. Provision of the electrical load forecast can be executed, for example, by an internal forecasting module of the energy system.

If, for example, the thermal system of a household comprises a thermal energy store and a heat generation installation, for example a heat pump and/or an electric boiler, which generates heat from power, and thus combines the domains of heat and power, the requisite electric power for covering the heat demand of a household can also be procured, in an optimum manner, on the local energy market. To this end, the temporal characteristic of thermal energy demand (thermal load forecast) is ascertained, and the electric power demand (electrical load forecast) for operating the heat generation installation is determined herefrom.

The electrical load forecast

$${p}_{t}^{e}$$

thus provided is transmitted to the control device. Further energy systems can also transmit a respective electrical load forecast to the control device. It is thus communicated to the central control device what (maximum) powers, and at what times, are to be extracted from, or injected into the power grid by each of the energy systems. Further data/information with respect to anticipated energy exchanges can be received from energy systems by the control device, in particular information on maximum installed loads, remuneration plans with respect to the injection and/or extraction of power and/or information on temporally displaceable loads (flexibility). The abovementioned information, together with electrical and thermal load forecasts, typically relate to an established time interval, for example a forthcoming day, in particular the next day.

Electric powers

$${P}_{t}^{e}$$

associated with energy exchanges are ascertained by the control device on the basis of envisaged electrical load forecasts

$${p}_{t}^{e}$$

thus transmitted. Ascertainment is executed using an optimization method, by reducing an associated target function. The target function is configured such that the number of starts

$${y}_{t}^{heat}$$

of the heat generation installation required for covering the envisaged thermal load

$${\dot{q}}_{t}^{thermal}$$

is minimized. The target function comprises electric powers

$${P}_{t}^{e}$$

and the number of starts

$${y}_{t}^{heat}$$

by way of variables, the values of which are ascertained by minimizing the target function. The target function can model further technical objectives, for example a minimum possible total emission of carbon dioxide, a maximum possible energy conversion and/or the lowest possible total costs.

By minimizing the starts of the heat generation installation, the envisaged thermal load is generated in the most efficient manner possible, in consideration of flexibilities (temporal displaceability of generation), with respect to wear of the heat generation installation. This applies on the grounds that typical heat generation installations undergo ageing, i.e. wear, according to their number of starts. The present methods thus enable an optimized operation of heat generation installations, with respect to wear. Heat generation installations can thus be more effectively integrated in a local energy market, as the specific technical requirements thereof are considered in a more effective manner.

Energy exchanges are controlled by means of the control device, according to the electric powers

$${P}_{t}^{e}$$

thus ascertained. Control is typically executed indirectly by the control device. By means of the optimization executed, the control device has ascertained target values (ascertained electric powers) for capacities on each energy system. These target values are then communicated to the respective energy systems. Within the energy systems, target values for powers are implemented by local control units and/or local regulation units, which transmit corresponding control signals to the respective installations, in particular to the heat generation installation.

Various embodiments of the teachings herein may provide one or more of the following:
a more efficient facility for the adjustment of offers/bids for heat generation installations, in particular heat pumps and/or electric boilers, to a local energy market;
an exploitation of potential flexibilities of thermal energy systems;
a cost saving for individual energy systems, associated with optimum energy procurement and reduced wear;
a facility for flexibility marketing, and thus an option for the generation of additional power proceeds in the energy system. This can be achieved if, for example, electricity demand for heat generation installations is serviced at a time of increased power injection from renewable energy generation into the overall system, and thus at low prices. The employment of a flexible supply of heat from the heat generation installation, particularly if a thermal energy store is available, represents a system service (negative controlling power), which might be correspondingly remunerated by the network operator;
an improved resource management of renewable energies associated with the employment of the offset potential of thermal energy stores. This can be achieved if, for example, electricity demand on the thermal system considered is serviced at a time of increased power injection from renewable energy generation, thus increasing the utilization factor of renewable generation. Alternatively, on the grounds of network overloads, the heat generation installation might be downregulated, in which case any potential thermal generation during this period would be lost; and/or
an improved sustainability of the entire energy system, associated with the exploitation of the potential flexibility of thermal energy stores. As a result, additional network extension can be avoided, without the additional installation of new storage systems. This can be achieved if, for example, the electricity demand of heat generation installations is serviced at a time of increased power injection from renewable energy generation into the overall system, and thus at low prices. As a result, firstly, injection spikes can be offset. Secondly, the electric power demand of heat generation installations at times of high consumption, for example in the morning hours and/or evening hours, is reduced, thus preventing load spikes.

An example control device incorporating teachings of the present disclosure for controlling energy exchanges between a plurality of energy systems via a power grid, wherein at least one of the energy systems comprises a heat generation installation which converts electrical energy from the power grid into heat, is characterized in that the control device is configured and designed:
to receive an electrical load forecast

$${p}_{t}^{e}$$

provided for the heat generation installation in order to cover an envisaged thermal load

$${\dot{q}}_{t}^{thermal} ,$$

and to receive further respective electrical load forecasts from the further energy systems;
to ascertain electric powers

$${P}_{t}^{e}$$

associated with energy exchanges on the basis of envisaged electrical load forecasts

$${p}_{t}^{e}$$

thus transmitted, which ascertainment is executed by means of an optimization method for minimizing an associated target function, which target function is designed such that the number of starts

$${y}_{t}^{h e a t}$$

of the heat generation installation for covering the envisaged thermal load

$${\dot{q}}_{t}^{thermal}$$

is minimized; and
to control energy exchanges according to the electric powers

$${P}_{t}^{e}$$

thus ascertained.

The methods described herein are associated with identical, equivalent and identically functioning advantages and/or configurations of the control device.

In some embodiments, the heat generation installation is configured as a heat pump. As a result, wear of heat pumps can be significantly reduced. This applies on the grounds that, in particular, heat pumps undergo wear according to the number of starts or compressor starts thereof. The more frequently heat pumps are activated, i.e. started, the higher the degree of wear thereof.

However, an optimum exploitation of the flexibility of heat generation, and thus of the operation of the heat generation installation, typically requires multiple start-ups and shutdowns of the heat generation installation. In the present case, it is thus possible to deliver heat or to cover a heat load, at least partially, and to simultaneously reduce wear associated with the temporal flexibility provided by the heat pump for the generation of heat.

In some embodiments, the heat generation installation can be configured as a water boiler.

In some embodiments, the electrical load forecast

$${p}_{t}^{e}$$

is ascertained from a thermal load forecast

$${\dot{q}}_{t}^{thermal}$$

according to

$${p}_{t}^{e} = {\dot{q}}_{t}^{thermal} / {COP}_{t} ,$$

wherein COPₜ is the performance index of the heat pump. The performance index of the heat pump is typically known, such that the electrical load forecast can be ascertained in an efficient and sufficiently approximative manner, by reference to the abovementioned relationship. Ascertainment of the electrical load forecast can be executed by the energy system itself and/or by the control device.

In some embodiments, an external temperature is captured, and the performances index COPₜ is determined according to the external temperature thus captured. The dependence of the provision of heat or heat generation upon the external temperature can thus be considered. In particular, this may be advantageous for heat pumps which employ air as a heat source. The influence of the heat source can thus be considered.

In some embodiments, the target function comprises a term having the formula

$${ξ}^{wear} \cdot {\sum }_{t} {y}_{t}^{h e a t}$$

for minimizing the number of starts

$${y}_{t}^{h e a t} ,$$

wherein ξ^{wear} is configured as a wear factor and

$${y}_{t}^{h e a t}$$

as a binary variable, which characterizes the number of starts. The target function can comprise further terms, which are minimized. In the optimization method, the entire target function is minimized accordingly. The binary variable

$${y}_{t}^{h e a t}$$

assumes a first and second value, e.g. the values 0 and 1, wherein the typically time-dependent value thereof is ascertained by minimizing the target function. Accordingly,

$${y}_{t}^{h e a t}$$

indicates the time at which the heat generation installation, in particular the heat pump, is started.

In some embodiments, further binary variables

$${x}_{t}^{h e a t} and {z}_{t}^{heat}$$

are employed in the optimization method, wherein

$${x}_{t}^{h e a t}$$

characterizes the operating status of the heat generation installation, and

$${z}_{t}^{h e a t}$$

characterizes the number of stops of the heat generation installation, and the ancillary conditions

$${x}_{t}^{h e a t} - {x}_{t - 1}^{h e a t} = {y}_{t}^{h e a t} - {z}_{t}^{h e a t} and {y}_{t}^{h e a t} + {z}_{t}^{h e a t} \leq 1$$

are employed in the optimization method. The optimization method can be improved as a result. In other words, by the employment of the abovementioned ancillary conditions in the optimization method, starts and stops of the heat generation installation, in particular of the heat pump, can be ascertained. By means of further binary variables, further technical requirements of the heat generation installation such as, for example, minimum run times and/or minimum downtimes of the heat generation installation, by way of

$${\sum }_{i = t - Δ {t}^{run , m i n}}^{t} {y}_{t}^{h e a t} \leq {x}_{t}^{h e a t} or {\sum }_{i = t - Δ {t}^{down , m i n}}^{t} {z}_{t}^{h e a t} \leq 1 - {x}_{t}^{h e a t} ,$$

can be employed as an ancillary condition in the optimization method, and considered accordingly.

In some embodiments, the energy system additionally comprises a thermal store which is thermally coupled to the heat generation installation, wherein the target function is configured such that storage losses of the thermal store are minimized. Storage losses from thermal energy stores can be minimized as a result. The system comprised of the heat generation installation and the thermal energy store can be modeled by

$${\dot{Q}}_{t}^{thermal} + {\dot{Q}}_{t}^{storage , charge} = {\dot{Q}}_{t}^{h e a t} + {\dot{Q}}_{t}^{storage , discharge} , wherein {\dot{Q}}_{t}^{t hermal}$$

characterizes the thermal load,

$${\dot{Q}}_{t}^{storage , charge}$$

characterizes the thermal charging capacity of the store,

$${\dot{Q}}_{t}^{heat}$$

characterizes the thermal power which is generated by the heat generation installation, and

$${\dot{Q}}_{t}^{storage , discharge}$$

characterizes the thermal discharge capacity of the store.

In some embodiments, the thermal energy store can be modeled by

$${E}_{t}^{storage} = {E}_{t - 1}^{storage} + Δ t ( {η}_{1} {\dot{Q}}_{t}^{storage , charge} - \frac{{\dot{Q}}_{t}^{storage , discharge}}{{η}_{2}} - {Q}_{t}^{storage , loss} ) \cdot {E}_{t}^{storage}$$

is the energy content of the store, Δt is a time increment, η₁ is a charge efficiency and η₂ is a discharge efficiency. Losses from the store associated with spontaneous discharge are modeled by

$${\dot{Q}}_{t}^{s t o r age , loss} .$$

The model can be employed in a flexible manner and provides sufficient accuracy for various storage technologies. Constant parameters such as, for example, the abovementioned efficiencies, can be determined using historic measurement data. By means of further measurements, the energy content of the store can be estimated, for example using available temperature sensors.

Losses associated with spontaneous discharge are described, in a simplified manner, by

$${\dot{Q}}_{t}^{storage , loss} = {φ}^{storage} {E}_{t - 1}^{storage} / Δ t ,$$

wherein the loss coefficient φ^{storage} can be estimated using historic measurement data.

The maximum and minimum storage content, and the maximum charging and discharge capacities can be estimated by means of system parameters such as, for example, maximum and minimum inlet and return temperatures, and connection line variables. These parameters limit the corresponding variables according to

$${E}^{storage , m i n} \leq {E}_{t}^{storage} \leq {E}^{storage , m ax} , \\ {\dot{Q}}^{storage , charge , m i n} \leq {\dot{Q}}_{t}^{storage , charge} \leq {\dot{Q}}^{storage , charge , ma x} and$$

$${\dot{Q}}^{storage , discharge , m i n} \leq {\dot{Q}}_{t}^{storage , discharge} \leq {\dot{Q}}^{storage , discharge , m ax} .$$

These ancillary conditions can be employed in the optimization method.

In some embodiments, the target function comprises a term having the formula

$${ξ}^{loss} \cdot {\sum }_{t} {\dot{Q}}_{t}^{t hermal}$$

for minimizing storage losses, wherein ξ^{loss} is a thermal weighting factor. As a result, storage losses can be considered in optimization, and minimized. In some embodiments, the target function comprises the term

$${ξ}^{loss} \cdot {\sum }_{t} {\dot{Q}}_{t}^{t hermal} + {ξ}^{wear} \cdot {\sum }_{t} {y}_{t}^{h e a t} ,$$

such that the latter is minimized. Further multiplicative numerical constants, for example time increments of optimization, Δt, can be provided. Moreover, wear and storage losses are weighted in a distinct manner by means of their respective weighting factors ξ^{wear}, ξ^{loss} In some embodiments, both terms can be divided by corresponding scaling factors, such that they assume the same numerical order of magnitude. Numerical analysis is thus advantageously improved.

The solution of the abovementioned optimization issue thus comprises an optimum trajectory for the power consumption of the heat generation installation, in particular of the heat pump, for the state-of-charge of the store, for the charging of the store and for the discharging of the store, with the lowest possible wear of the heat generation installation.

In some embodiments, the further ancillary condition

$${P}_{t}^{e , m i n} {x}_{t}^{h e a t} \leq {P}_{t}^{e} \leq {P}_{t}^{e , m ax} {x}_{t}^{heat}$$

is employed in the optimization method, wherein

$${P}_{t}^{e , m i n}$$

is a minimum making capacity and

$${P}_{t}^{e , max}$$

is the rated capacity of the heat generation installation. As a result, technical performance limits of the heat generation installation are considered in the optimization method. In other words, an outcome of optimization can be ascertained which observes the technical performance limits of the heat generation installation.

The present exemplary embodiment is based upon a building (energy system) which comprises a heat pump for the at least partial coverage of the heat demand thereof. The energy system can further comprise an energy store, for example a water store, which is thermally coupled to the heat pump.

For the energy system, a thermal load forecast can be ascertained for a future time segment. From the thermal load forecast thus ascertained, an electrical load forecast for the heat pump can be ascertained, for example by reference to the performance index thereof. The thermal energy store can thus be considered. The electrical load forecast thus ascertained can be met by a corresponding supply on a local energy market. The local energy market is constituted by a control device which is central to multiple energy systems, and which controls energy exchanges between the energy systems. To this end, the control device ascertains time-dependent target powers for each of the energy systems, by means of a numerical optimization method.

In a first step S1, the electrical load forecast for the heat pump is thus ascertained for the at least partial coverage of the anticipated thermal load. It is thus known what electric power is to be extracted from the power grid, and at what time, in order to cover the corresponding thermal load.

In a second step S2, the electrical load forecast thus provided is transmitted to the control device of the local energy market. All participating energy systems in the local energy market also transmit their electrical load forecasts to the control device. The control device then executes an optimum matching of these forecasts, with respect to a target function, by means of an optimization method.

In a third step S3, electric powers associated with energy exchanges are ascertained by the control device on the basis of envisaged electrical load forecasts thus transmitted, which ascertainment is executed using the optimization method, by minimizing an associated target function. The target function is configured or saved such that at least the number of starts of the heat pump required for covering the envisaged thermal load is minimized. As a result, advantageously, wear of the heat pump is reduced, and the temporal flexibility of heat generation by the heat pump, which typically increases the number of starts, can nevertheless be exploited, enabling optimum coverage of the thermal load.

In a further step S4, finally, electric powers or target powers ascertained by means of the optimization method are implemented. In other words, the control of energy exchanges is executed according to the electric powers thus ascertained, by means of the control device. As a result, energy exchanges are executed between energy systems, via the power grid.

Although the teachings of the present disclosure have been illustrated and described in greater detail with reference to exemplary embodiments, the scope of the disclosure is not limited by the examples disclosed, or further variations can be inferred herefrom by a person skilled in the art, without departing from the protective scope thereof.

### LIST OF REFERENCE SYMBOLS

S1 First step
S2 Second step
S3 Third step
S4 Fourth step

What is claimed is:

1. A method for controlling energy exchanges between a plurality of energy systems via a power grid using a central control device, wherein at least one of the energy systems comprises a heat generation installation which converts electrical energy from the power grid into heat, the method comprising:
providing an electrical load forecast
$${p}_{t}^{{}_{e}}$$
for the heat generation installation required to cover an envisaged thermal load
$${\dot{q}}_{t}^{thermal} ;$$
transmitting the electrical load forecast
$${p}_{t}^{{}_{e}}$$
to the control device, wherein other energy systems also transmit respective electrical load forecasts to the control device;
ascertaining electric powers
$${P}_{t}^{{}_{e}}$$
associated with energy exchanges using the control device, on the basis of transmitted electrical load forecasts
$${p}_{t}^{{}_{e}}$$
executed by an optimization method for minimizing an associated target function minimizing a number of starts
$${y}_{t}^{{}_{heat}}$$
of the heat generation installation for covering the envisaged thermal load
$${\dot{q}}_{t}^{thermal}$$
and
controlling energy exchanges according to the electric powers
$${P}_{t}^{{}_{e}}$$
using the control device.

2. The method as claimed in claim 1, wherein the heat generation installation comprises a heat pump.

3. The method as claimed in claim 2, wherein the electrical load forecast
$${p}_{t}^{{}_{e}}$$
is ascertained from a thermal load forecast
$${\dot{q}}_{t}^{{}_{thermal}} according to {p}_{t}^{{}_{e}} = {\dot{q}}_{t}^{thermal} / {COP}_{t} ,$$
wherein COPₜ is a performance index of the heat pump.

4. The method as claimed in claim 3, further comprising capturing an external temperature, and the performance index COPₜ is determined using the external temperature.

5. The method as claimed in claim 1, wherein the target function comprises a term
$${ξ}^{wear} \cdot {\sum }_{t} {y}_{t}^{{}_{heat}}$$
for minimizing the number of starts
$${y}_{t}^{{}_{heat}} , wherein {ξ}^{wear}$$
is configured as a wear factor and
$${y}_{t}^{{}_{heat}}$$
as a binary variable representing the number of starts.

6. The method as claimed in claim 5, wherein further binary variables
$${x}_{t}^{{}_{heat}} and {z}_{t}^{{}_{heat}}$$
are employed in the optimization method, wherein
$${x}_{t}^{heat}$$
characterizes the operating status of the heat generation installation and
$${z}_{t}^{heat}$$
characterizes the number of stops of the heat generation installation, and the ancillary conditions
$${x}_{t}^{heat} - {x}_{t - 1}^{heat} = {y}_{t}^{heat} - {z}_{t}^{heat} and {y}_{t}^{h e a t} + {z}_{t}^{h e a t} \leq 1$$
are employed in the optimization method.

7. The method as claimed in claim 1, wherein:
the energy system comprises a thermal store thermally coupled to the heat generation installation; and
the target function is configured such that storage losses of the thermal store are minimized.

8. The method as claimed in claim 7, wherein the target function comprises a term
$${ξ}^{loss} \cdot {\sum }_{t} {\dot{Q}}_{t}^{thermal}$$
for minimizing storage losses, wherein ξ^{loss} is a thermal weighting factor.

9. The method as claimed in claim 1, wherein further ancillary condition
$${P}_{t}^{e , m i n} {x}_{t}^{heat} \leq {P}_{t}^{e} \leq {P}_{t}^{e , m ax} {x}_{t}^{heat}$$
is employed in the optimization method, wherein
$${P}_{t}^{e , m i n}$$
is a minimum making capacity and
$${P}_{t}^{e , m ax}$$
is the rated capacity of the heat generation installation.

10. A control device for controlling energy exchanges between a plurality of energy systems via a power grid, wherein at least one of the energy systems comprises a heat generation installation which converts electrical energy from the power grid into heat, characterized in that the control device is configured and designed:
to receive an electrical load forecast
$${p}_{t}^{e}$$
provided for the heat generation installation in order to cover an envisaged thermal load
$${\dot{q}}_{t}^{thermal} ,$$
and to receive further respective electrical load forecasts from the further energy systems;
to ascertain electric powers
$${P}_{t}^{e}$$
associated with energy exchanges on the basis of envisaged electrical load forecasts
$${p}_{t}^{e}$$
thus transmitted, which ascertainment is executed by means of an optimization method for minimizing an associated target function, which target function is designed such that the number of starts
$${y}_{t}^{h e a t}$$
of the heat generation installation for covering the envisaged thermal load
$${\dot{q}}_{t}^{thermal}$$
is minimized; and
to control energy exchanges according to the electric powers
$${P}_{t}^{e}$$
thus ascertained.
